(19) United States
(12) Patent Application Publication
(10) Pub. No.: US 2009/0068047 A1
(43) Pub. Date: Mar. 12, 2009

(54) Closed Type Fluid Machine

(76) Inventors: Yoshitaka Koitabashi, Saitama (JP); Shigeyuki Koyama, Gunma (JP); Kou Tsukamoto, Gunma (JP); Tomokazu Naruta, Gunma (JP)

Correspondence Address: BAKER BOTTS LLP;C/O INTELLECTUAL PROPERTY DEPARTMENT, THE WARNER, SUITE 1300, 1299 PENNSYLVANIA AVE, NW, WASHINGTON, DC, 20004-2400, US

(21) Appl. No.: 11/913,712

(22) PCT Filed: Apr. 24, 2006
(86) PCT No.: PCT/JP2006/308526

§ 371 Date: Nov. 6, 2007

(30) Foreign Application Priority Data
May 6, 2005 (JP) 2005-135090

(51) Int. Cl. F04C 29/06; F04B 53/16; G10K 11/162; F04C 18/02

(52) U.S. Cl. 418/55.2; 417/410.5; 181/213

(57) ABSTRACT

An electric scroll compressor (1) as a closed type fluid machine, comprising a housing (10) in which a scroll unit (18) and an armature (40) driving the scroll unit (18) are contained. A resin coating layer (72) with a thickness of 50 μm or more is formed on at least a part of the outer surface of the housing (10). A silent closed type fluid machine can be thus provided without increasing size and deteriorating productivity.

### TECHNICAL FIELD OF THE INVENTION

The present invention relates to a closed type fluid machine, and specifically, to a closed type fluid machine the noise and vibration of which are decreased.

### BACKGROUND ART OF THE INVENTION

A closed type fluid machine is applied, for example, to a refrigeration circuit of a refrigerator as a compressor, and in its housing, a fluid pressure unit for an operational fluid, that is, a compression unit and an armature for driving the compression unit, are contained.

There is a machine provided with a soundproof casing outside the housing as such a closed type fluid machine, and this soundproof casing functions for decreasing the noise transmitted to outside during operation of the fluid machine (Patent document 1).

Patent document 1: JP-A-2003-201961

### DISCLOSURE OF THE INVENTION

### Problems to be Solved by the Invention

In the closed type fluid machine disclosed in Patent document, however, there is a problem that the size of the whole of the machine increases by attaching the soundproof casing thereto. Further, although the outer shape of a closed type fluid machine varies depending upon its specification, if the soundproof casing is made in accordance with such an outer shape, the productivity of the fluid machine may decrease and the cost may increase.

Paying attention to the above-described problems, an object of the present invention is to provide a silent closed type fluid machine inexpensively without causing increase of size and deterioration of productivity.

### Means for Solving the Problems

To achieve the above-described object, a closed type fluid machine according to the present invention has a housing in which a fluid pressure unit and an armature interlocking with the fluid pressure unit are contained, and is characterized in that a resin coating layer with a thickness of 50 μm or more is provided on at least a part of an outer surface of the housing. Namely, it is structured wherein a resin coating layer is provided on the housing itself without using a soundproof casing as in the conventional structure.

Although advantages of a good noise absorption or shield and a good vibration absorption or damping can be obtained as long as the coating layer has a thickness of 50 μm or more, more preferably, the coating layer has a thickness of 1.0 mm or more.

Further, although the kind of the resin of the coating layer is not particularly limited as long as it can decrease noise and vibration, it is preferred that the coating layer is made from a foamed resin, from the viewpoint that an excellent effect for decreasing noise and vibration can be obtained while the layer is maintained light in weight.

Furthermore, the fluid pressure unit also is not particularly limited as long as it can compress or expand an operational fluid, and as a typical unit, a scroll unit can be exemplified.

### EFFECT ACCORDING TO THE INVENTION

In the closed type fluid machine according to the present invention, by the resin coating layer provided on the outer surface of the housing itself, an effect for absorbing or shielding an operational sound (noise) and absorbing or damping a vibration, which are transmitted to outside of the fluid machine, can be obtained, and these operational sound and vibration can be decreased. In particular, by making the thickness of the resin coating layer at 50 μm or more, an excellent property for decreasing the operational sound and vibration can be exhibited. Therefore, as compared with a conventional structure in which a soundproof casing is used, by this coating layer, a silent property of the fluid machine can be obtained while increase of the size of the fluid machine can be prevented. Further, it is not necessary to make a soundproof casing in accordance with the outer shape of the housing, and reduction of the productivity of this closed type fluid machine can be suppressed.

Further, if the coating layer is made from a foamed resin, while increase of the weight can be suppressed, it becomes possible to decrease the operational sound (noise) and vibration transmitted to outside, more efficiently.

### BRIEF EXPLANATION OF THE DRAWINGS

FIG. 1 is a vertical sectional view of a closed type fluid machine according to an embodiment of the present invention.

### EXPLANATION OF SYMBOLS

1: electric scroll compressor as a closed type fluid machine
10: housing
12: unit casing
16: stator casing (housing)
18: scroll unit (fluid pressure unit)
40: armature
42: rotational shaft
58: stator
72: coating layer

### THE BEST MODE FOR CARRYING OUT THE INVENTION

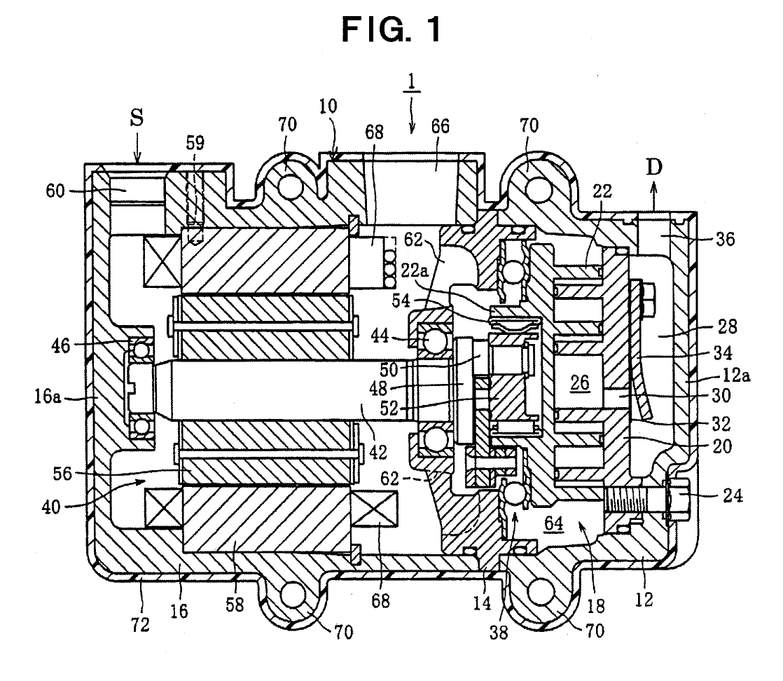

FIG. 1 depicts an electric scroll compressor 1 as a closed type fluid machine according to an embodiment of the present invention. This compressor 1 is used, for example, as a compressor for a refrigeration circuit of a refrigerator. Compressor 1 has a cylindrical housing 10, and this housing 10 has a unit casing 12, a support wall 14 and a stator casing 16 in order from the right side in FIG. 1. Unit casing 12 and stator casing 16 are both formed from an aluminum, and they are connected to each other via support wall 14 positioned therebetween. Where, casings 12 and 16 and support wall 14 are connected at gas-tight conditions via O-rings, respectively.

A scroll unit 18 as the fluid pressure unit is contained in unit casing 12, and this scroll unit 18 has a fixed scroll 20 and a movable scroll 22. Movable scroll 22 is disposed on the side of support wall 14, and fixed scroll 20 is fixed to an end wall 12a of unit casing 12 via a plurality of fastening bolts 24. Fixed and movable scrolls 20 and 22 are assembled so that the scroll walls thereof engage with each other, and a plurality of compression chambers 26 (fluid pockets) are formed between the scroll walls. These compression chambers 26 move toward the center of fixed scroll 20 accompanied with the orbital movement of movable scroll 22 relative to fixed scroll 20, and the volumes thereof decrease during the movement process, thereby compressing the fluid in the compression chambers 26.

In unit casing 12, a discharge chamber 28 is formed between fixed scroll 20 and end wall 12a, and a through discharge hole 30 is formed on the central portion of fixed scroll 20. The above-described compression chambers 26 are communicated with this discharge hole. 30 in order, and the discharge hole 30 is opened/closed by a discharge valve 32 formed as a lead valve. Discharge valve 32 is attached on the end surface of discharge chamber 28 side of fixed scroll 20 via a bolt. and its opening degree is regulated by a retainer 34.

Further, a discharge port 36 is formed on the outer circumferential wall of unit casing 12, and fluid D discharged through this discharge port 36 from discharge chamber 28 is sent to the refrigerant circulation route (not shown) of the aforementioned refrigeration circuit.

Movable scroll 22 is served to an orbital movement relative to fixed scroll 20 by receiving a power from the electric motor formed using armature 40, and at that time, movable scroll 22 is in a condition prevented with rotation. Therefore, a ball coupling 38 is interposed between movable scroll 22 and support wall 14, this ball coupling 38 prevents the rotation of movable scroll 22 as well as functions to receive a thrust load from movable scroll 22, and the thrust load is transmitted to support wall 14 via ball coupling 38.

The above-described electric motor has armature 40 contained in stator casing 16, and rotational shaft 42 is disposed at the central portion of this armature 40. Rotational shaft 42 extends between support wall 14 and end wall 16a of stator casing 16, and it is supported at a condition free to rotate by these support wall 14 and end wall 16a via ball bearings 44 and 46.

One end of rotational shaft 42 is formed as a large-diameter end portion 48, and this large-diameter end portion 48 is disposed so as to project from support wall 14 into unit casing 12. A crank pin 50 is projected from large-diameter end portion 48 toward movable scroll 22 side, and an eccentric bush 52 is attached to crank pin 50. This eccentric bush 52 is supported free to rotate by boss 22a of movable scroll 22 via needle bearing 54.

Therefore, when rotational shaft 42 is rotated, the rotational force of rotational shaft 42 is transmitted to movable scroll 22 via crank pin 50, eccentric bush 52 and needle bearing 54, and as a result, movable scroll 22 is served to an orbital movement relative to fixed scroll 20 at a condition prevented with rotation by ball coupling 38, and the radius of the orbital movement is decided by the distance between the axes of rotational shaft 42 and crank pin 50.

Armature 40 has a rotor 56 fixed to rotational shaft 42, and this rotor 56 is surrounded by stator 58. Stator 58 has an outer diameter nearly equal to the inner diameter of stator casing 16, and it is fixed relative to housing 10, that is, stator casing 16, by fastening bolts (not shown). Where, a screw 59 for positioning is provided to stator 58, which extends in the radial direction through the outer circumferential wall of stator casing 16.

A suction port 60 is formed on the outer circumferential wall of stator casing 16, and this suction port 60 is disposed at a position near end wall 16a of stator casing 16. Suction port 60 is communicated with the inside of stator casing 16 as well as connected to the refrigerant circulation route of the aforementioned refrigeration circuit, and it ca flow refrigerant S from the refrigerant circulation route into stator casing 16.

The refrigerant flowed into stator casing 16 is directed to support wall 14 side through a gap in armature 40, that is, a gap between rotor 56 and stator 58 and an axial gap secured in stator 58, and the refrigerant is introduced from the inside of stator casing 16 into unit casing 12 through a plurality of communication holes 62 formed on support wall 14.

Namely, a refrigerant route from suction port 60 to the inside of unit casing 12 is secured in stator casing 16, and a portion in unit casing 12 introduced with refrigerant is formed as suction chamber 64. This suction chamber 64 surrounds movable scroll 22 of scroll unit 18, and the suction chamber 64 is partitioned relative to discharge chamber 28 by fixed scroll 20.

Further, a power supply port 66 is formed on the outer circumferential wall of stator casing 16, the power supply port 66 is usually in a condition closed by a plug, and lead wires (not shown) connecting between a coil 68 of stator 58 and the external power supply circuit are led out through the plug at a gas-tight condition.

On the other hand, mount portions 70 are provided to housing 10 for bolt fastening compressor 1 to a refrigerator and the like, and two mount portion 70 project from each outer circumferential wall of unit casing 12 and stator casing 16. In each casing 12, 16, mount portions 70 are apart from each other in the diameter direction, and one mount portion 70 is disposed at a position on the same side as discharge port 36, suction port 60 and power supply port 66, that is, at an upper position in FIG. 1.

Further, the above-described housing 10 of compressor 1 is coated with a resin coating layer 72 over the entire area of the outer surface. In this embodiment, coating layer 72 is formed from a foamed urethane resin. Although a good effect for decreasing operational sound and vibration can be obtained if the thickness of coating layer 72 is 50 μm or more, in this embodiment, the thickness is set at 1.5 mm or more in order to obtain a more excellent effect. In more detail, the outer circumferential walls and end walls 12a, 16a of unit casing 12, support wall 14 and stator casing 16 are covered with the above-described coating layer 72 at portions except the respective open ends of discharge port 36, suction port 60, power supply port 66 and the bolt holes of mount portions 70.

Such a coating layer 72 can be formed by spray coating, dipping and the like after masking the open ends of discharge port 36, etc. after assembling compressor 1. However, it is possible to provide coating layer 72 to housing 10 beforehand prior to the assembly of compressor 1.

In the above-described scroll compressor 1, rotor 56 is rotated together with rotational shaft 42 by the electromagnetic force of coil 68 and stator 58 power supplied, and by this, movable scroll 22 is served to an orbital movement via eccentric bush 52, etc. Accompanied with this orbital movement, when compression chamber 26 is opened to suction chamber 64, the compression chamber 26 sucks a fluid (for example, refrigerant) present in suction chamber 26, and the sucked refrigerant is compressed at a process where the compression chamber 26 moves toward discharge hole 30 of fixed scroll 20. When compression chamber 26 reaches discharge hole 30 and the pressure in the compression chamber 26 exceeds the shut pressure of discharge valve 32, the discharge valve 32 is opened and the compressed refrigerant in the compression chamber 26 is discharged into discharge chamber 28 through discharge hole 30.

Thereafter, the compressed refrigerant is sent from discharge chamber 28 to the refrigerant circulation route through discharge port 36, the refrigerant passes through the condenser, the receiver, the expansion valve and the evaporator and reaches suction port 60, and then, the refrigerant passes through the aforementioned refrigerant route in stator casing 16 from this suction port 60 and is returned to suction chamber 64.

In the above-described compressor 1, during its operation, a vibration ascribed to the rotation of rotor 56 and the orbital movement of the movable scroll accompanied therewith is generated, and sliding sounds at bearings 44, 46 and 54 and at the sliding portions of fixed and movable scrolls 20 and 22 and an opening/closing sound of discharge valve 32 are generates as an operational sound.

Although these operational sound and vibration are transmitted to the outer surface of housing 10, that is, the outer circumferential walls and end walls 12a, 16a of unit casing 12, support wall 14 and stator casing 16, in this compressor 1, these operational sound and vibration are absorbed by coating layer 72 made of a foamed resin, and the operational sound and vibration being transmitted to outside can be decreased. Namely, by the coating layer 72, an operational sound (noise) and a vibration leaked from compressor 1 to outside of a refrigerator and the like can be decreased.

Therefore, by providing this coating layer 72, as compared with the conventional case using a soundproof casing, while an increase of the size of compressor 1 can be prevented, the silent property of compressor 1 can be ensured. Further, this coating layer 72 can be easily formed by painting and the like without depending upon the outer shape of housing 10, and in this compressor 1, a reduction of the productivity can also be suppressed. Moreover, by this coating layer 72, even if the O-rings are deteriorated as the time passes, a leakage of refrigerant from a connection portion between casing 12 or 16 and support wall 14 can also be prevented.

Furthermore, because the electric insulation at the outer surface of housing 10 is secured by this coating layer 72, even if an interior short in the electric circuit in housing 10 occurs, an electric leakage to outside of compressor 1 can be prevented.

The present invention is not limited to the above-described embodiment, and various modifications are possible. For example, the material for coating layer 72 is not particularly limited, a resin capable of absorbing the operational sound can be used, and even by forming an epoxy resin coating layer 72 with a thickness of 50 μm or more, an effect for the silent property can be obtained. In order to absorb the operational sound efficiently, in particular, it is preferred to use a foamed resin for coating layer 72, and further, although the thickness of coating layer 72 may be 50 μm or more, the thickness is preferably 1.0 mm or more, and more preferably 1.5 mm or more as in the above-described embodiment.

Although coating layer 72 covers almost the entire region of the outer surface of housing 10 in the above-described embodiment, if at least a part of the outer surface is covered, it is possible to obtain an effect for decreasing the operational sound and vibration. For example, a structure may be employed wherein only portions of housing 10 easily transmitting the operational sound to outside by own vibration, such as end walls 12a, 16a of casings 12, 16, etc., are covered with the coating layer. However, from the viewpoint of further decreasing the operational sound, as in the above-described embodiment, it is preferred to form coating layer 72 substantially over the entire region of the outer surface of housing 10.

Although compressor 1 has scroll unit 18 as a compression unit for compressing the operational fluid in the above-described embodiment, a reciprocating type compression unit such as an inclined plate type may be employed.

Further, it is possible to use the closed type fluid machine according to the present invention as an expander except a compressor. In such a case, the compression unit is utilized as an expansion unit, rotor 56 is rotated by an orbital movement of movable scroll 22 caused by the expansion of the operational fluid, and electric power generated at armature 40 at that time can be taken out.

### INDUSTRIAL APPLICATIONS OF THE INVENTION

The present invention can be applied to any closed type fluid machine in which a fluid pressure unit and an armature interlocking with the fluid pressure unit are contained the housing.

1. A closed type fluid machine having a housing in which a fluid pressure unit and an armature interlocking with said fluid pressure unit are contained, comprising:
a resin coating layer with a thickness of 50 μm or more provided on at least a part of an outer surface of said housing.

2. The closed type fluid machine according to claim 1, wherein said coating layer has a thickness of 1.0 mm or more.

3. The closed type fluid machine according to claim 1, wherein said coating layer is made from a foamed resin.

4. The closed type fluid machine according to claim 1, wherein said fluid pressure unit is a scroll unit.
